(19) United States
(12) Patent Application Publication
(10) Pub. No.: US 2026/0021734 A1
(43) Pub. Date: Jan. 22, 2026

(54) VEHICLE-TO-VEHICLE CHARGING UNIT AND PROCESS

(71) Applicant: GM GLOBAL TECHNOLOGY OPERATIONS LLC, Detroit, MI (US)

(72) Inventors: Rashmi Prasad, Troy, MI (US); Chandra S. Namuduri, Troy, MI (US); Zhen J. Zhang, Canton, MI (US); David W. Walters, Sterling Heights, MI (US); Sandeep U. Menon, Troy, MI (US)

(73) Assignee: GM GLOBAL TECHNOLOGY OPERATIONS LLC, Detroit, MI (US)

(21) Appl. No.: 18/777,685

(22) Filed: Jul. 19, 2024

(51) Int. Cl. B60L 53/57; B60L 53/10; B60L 53/302; B60L 53/53; B60L 53/65; B60L 53/66; G06N 20/00

(52) U.S. Cl. CPC B60L 53/57; B60L 53/11; B60L 53/302; B60L 53/53; B60L 53/65; B60L 53/665; G06N 20/00; B60L 2210/10; B60L 2260/46

(57) ABSTRACT

A charging unit for use by a charge-receiving electrical system (“recipient”) and a charge-providing electrical system (“donor”) includes a housing and an auxiliary battery. A bi-directional, buck-boost high-voltage (HV)-to-HV converter is connected to an HV bus between disconnect devices. A bi-directional, buck-boost HV-to-LV converter is connected to the HV bus and a low-voltage (LV) bus. A supply equipment communication controller (SECC) detects charge port control signals and establishes communication between the SECC and a system controller. Separate donor and recipient monitoring circuits determine an isolation state of the HV bus and a state of the disconnect devices. During the charging process, the system controller selectively commands offloading of a charging current from an energy storage system of the donor, through the HV-to-HV converter, and to an energy storage system of the recipient.

### INTRODUCTION

Battery electric vehicles as well as plug-in hybrid electric vehicles and extended-range electric vehicles, collectively referred to herein as EVs for simplicity, are equipped with an electrified powertrain system. An electrified powertrain system includes one or more electric traction motors. The motors are connected to a set of road wheels of the EV. A battery management system of the EV controls discharge of a high-voltage traction battery pack during propulsion modes to energize phase windings of the motor(s) and produce output torque. The EV is thus propelled along a road surface via electrically-driven rotation of the road wheels, with engine-drive rotation remaining possible in the above-noted hybrid electric and extended-range configurations.

Electrochemical battery cells of a depleted traction battery pack are selectively rechargeable using an offboard plug-in charging process. As appreciated in the art, offboard charging of a battery electric system requires the battery pack to be electrically connected to Electric Vehicle Supply Equipment (EVSE), i.e., an offboard charging station, via a suitably configured charging cable. Requisite communication and control circuitry and associated controllers of the charging station and EV establish two-way communication in accordance with a suitable charging protocol. The charging station thereafter offloads a charging current to the depleted traction battery pack to recharge the individual battery cells. When a charge-donating node and a charge-receiving node engage in the transfer/receipt of a direct current (DC) charging waveform, the exchange is referred to in that art as DC-DC charging.

### SUMMARY

Disclosed herein are a dual-sided charging unit and a corresponding computer-based charging process. The charging unit, portable in some implementations, is configured for performing a direct current-to-direct current (DC-DC) charging operation between a charge-donating node (“donor”) and a charge-receiving node (“recipient”) in the form of respective first and second electric systems. The disclosed charging architecture, control circuitry, and charging strategy collectively enable energy transfer between the donor and recipient, for instance when an offboard charging station is not readily available.

In a representative construction as set forth herein, the donor and recipient are both configured as electric vehicles (EVs), for instance battery electric vehicles, plug-in hybrid electric vehicles, extended range electric vehicles, or another electrified mobile system capable of performing the disclosed functions. The present teachings may also be extended to DC-DC charging events performed using stationary or non-vehicular electric systems within the scope of the present disclosure.

In a particular embodiment, a charging unit for performing a charging process between a donor and a recipient includes a housing, an auxiliary battery or another rechargeable energy storage system (RESS) connected to the housing, a high-voltage (HV) bus, and a system controller. The housing includes a donor charging port and a recipient charging port that are selectively connectable to the donor and the recipient, respectively, via corresponding charging cables and connectors. Packaged within the housing in this embodiment are the HV bus having donor and recipient HV disconnect devices, with the HV bus being connectable to the donor and recipient via the donor and recipient HV disconnect devices, respectively. Also packaged within the housing is a low-voltage (LV) bus having an auxiliary switch, e.g., manually-actuated push button device, a smart switch, or a switching device activated by a control signal from a human-machine interface (HMI) or another external device, or a command from a mobile app. A bi-directional buck-boost HV-to-HV converter is connected to the HV bus between the donor and recipient HV disconnect devices. A bi-directional buck-boost HV-to-LV converter is connected to the HV and LV busses.

The system controller in one or more embodiments is connectable to the LV bus via the above-noted auxiliary switch. A supply equipment communication controller (SECC) is configured to detect charge port control signals via the donor and recipient charging ports, and to establish communications between the SECC and the system controller in response to the charge port signals. Respective donor and recipient isolation monitoring circuits are configured to determine an isolation state of the HV bus and an OPEN/CLOSED state of the donor and recipient disconnect devices, e.g., HV contactors. The system controller is connectable to the auxiliary battery and is in communication with the HV-to-HV converter, the HV-to-LV converter, the donor and recipient HV disconnect devices, and the SECC. The system controller selectively commands an offloading of a DC charging current from a battery pack of the donor, through the HV buck-boost converter, and to a battery pack or other RESS of the recipient.

The donor and recipient monitoring circuits may respectively include first and second electrical sensors each configured to measure a corresponding voltage and current on the HV bus.

The charging unit may also include a thermal management system (TMS) connected to the auxiliary battery, the HV-to-HV converter, and the HV-to-LV converter, along with a relay that selectively disconnects the TMS from the auxiliary battery in response to a relay control signal from the system controller. The TMS in one or more embodiments may include a motorized fan and/or pump configured to circulate air or coolant to the HV-to-HV converter and the HV-to-LV converter when the fan or pump are connected to the auxiliary battery.

Aspects of the disclosure pertain to an HMI connected to the housing. The HMI is configured to receive user inputs to the system controller and to display information pertaining to the charging process.

Embodiments of the system controller are configured to quantify the charging process upon completion thereof, generate a summary of charges for the charging process, and communicate the summary of charges to a user of the recipient. The system controller may also be configured to perform an adaptive self-learning algorithm to analyze charging behavior of a group of recipients from prior charging processes, and to adjust performance of the charging unit over time based on the charging behavior.

The recipient and the donor are optionally configured as electric vehicles (EVs), in which case the charging process is a vehicle-to-vehicle (V2V) charging process. The donor and recipient HV disconnect devices may include contactors as noted above, or single-pull single-throw switches or solid-state relays (SSRs) in representative embodiments.

Some implementations of the charging unit have a unique identifier (ID) code. The charging unit may remotely enable pairing of the donor and server in response to the unique ID code matching a corresponding ID code stored in respective memory of the donor and the recipient.

Also disclosed herein is a V2V charging process. An embodiment of such a process includes energizing a system controller of a V2V charging unit via an LV bus in response to actuation of an auxiliary switch, and detecting charge port control signals via an SECC of a V2V charging unit. The charge port signals are indicative of an electrical connection of a donor and a recipient, e.g., EVs. The process include establishing handshaking/communications between the SECC and a system controller of the V2V unit in response to the charge port control signals to thereby initiate a V2V charging process.

During the V2V charging process, the process includes commanding separate donor and recipient HV disconnect devices on an HV bus of the V2V charging unit to close, via the system controller, thereby connecting a bi-directional, buck-boost HV-to-HV converter to the HV bus, recharging the LV bus via a bi-directional, buck-boost HV-to-LV converter, and monitoring separate donor and recipient monitoring circuits of the V2V charging unit to determine an isolation state of the HV bus and an OPEN/CLOSED state of the donor and recipient HV disconnect devices. The process also includes selectively commanding an offloading of a DC charging current from a battery pack of the donor, through the HV-to-HV converter, and to a battery pack of the recipient.

Aspects of the disclosure also pertain to a vehicle system having a donor EV having a first traction battery pack, a recipient EV having a second traction battery pack, and a V2V charging unit configured as summarized above.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a direct current-to-direct current (DC-DC) charging process in the form of a representative vehicle-to-vehicle (V2V) charging process, with the V2V charging process performed between a charge-providing electric vehicle (“donor”) and a charge-receiving electric vehicle (“recipient”) using a V2V charging unit in accordance with an aspect of the present disclosure.

FIG. 2 illustrates a representative embodiment of the V2V charging unit of FIG. 1.

FIGS. 3A, 3B, and 3C collectively form a flow chart describing a process for using the V2V charging unit of FIGS. 1 and 2 during a representative V2V charging process.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

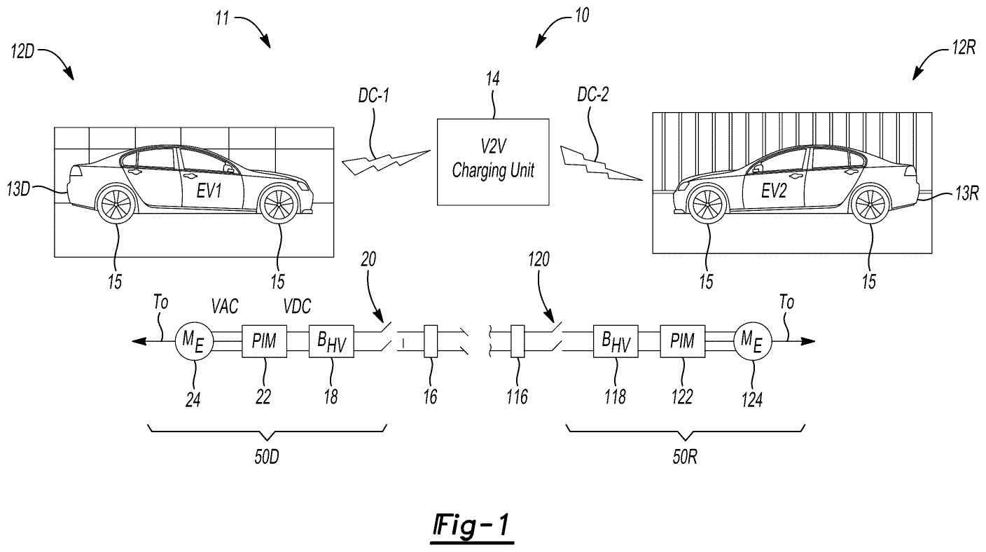

Referring to the drawings, wherein like reference numbers refer to like features throughout the several views, FIG. 1 depicts direct current-to-direct current (DC-DC) charging performed via a representative vehicle-to-vehicle (V2V) charging process 10 involving a vehicle system 11 having a charge-providing battery electric system 12D and a charge-receiving battery electric system 12R. During the illustrated V2V charging process 10, the charge-providing battery electric system 12D, hereinafter referred to as a donor 12D for clarity, offloads a high-voltage direct current (DC) charging current (DC-1) to a portable V2V charging unit 14. The V2V charging unit 14 in turn delivers a DC charging current (DC-2) to a charge-receiving battery electric system 12R, hereinafter referred to as a recipient 12R. From the perspective of the recipient 12R, the donor 12D and the V2V charging unit 14 appear as electric vehicle supply equipment (EVSE), i.e., an offboard charging station. However, in contrast to stationary offboard charging stations capable of providing direct current (DC) charging functionality, the optional portability and configured functionality of the V2V charging unit 14 as described below offers owners/operators of electrified systems the benefit of enhanced charging mobility and reduced range anxiety, among other attendant benefits.

As illustrated in FIG. 1, the donor 12D and recipient 12R may be optionally constructed as electric vehicles EV1 and EV2, respectively. As used herein, “electric vehicle” may encompass a wide range of mobile electrified systems, including but not limited to battery electric vehicles, hybrid electric vehicles, extended-range electric vehicles, etc. Although motor vehicles are shown in FIG. 1 to illustrate a possible implementation, those skilled in the art will appreciate that the present teachings may be extended to a host of electrical systems, including rail vehicles, aircraft, boats, farm vehicles, delivery or transportation vehicles, etc. The illustrated motor vehicle scenario of FIG. 1 is therefore illustrative of just one possible approach and non-limiting unless otherwise specified.

In the representative construction of FIG. 1, the donor 12D and the recipient 12R may include a body 13D, 13R and a corresponding electric powertrain system 50D and 50R. In a typical configuration, the donor 12D includes a charging port 16 that is connected to a high-voltage (HV) electrochemical traction battery pack (BHV) 18 (or another rechargeable energy storage system such as a capacitor bank) via a set of main DC fast-charging (DCFC) contactors 20 or other suitable high-voltage electrical switches. The traction battery pack 18 is connected to a power inverter module (PIM) 22, i.e., an inverter circuit. During a discharging mode of the battery pack 18, the battery pack 18 delivers a DC voltage (VDC) to a DC-side of the PIM 22. The PIM 22, using ON/OFF conductive state control of multiple solid-state semiconductor switches (not shown) such as insulated-gate bipolar transistors (IGBTs), metal-oxide-semiconductor field effect transistors (MOSFETs), thyristors, or the like, is driven by pulse-width modulation or another suitable switching control technique to convert a DC voltage waveform to an alternating current (AC) voltage waveform and vice versa, as appreciated in the art. That is, switching control of the PIM 22 ultimately converts the DC input voltage from the battery pack 18 into an AC voltage (VAC) suitable for energizing phase windings of an electric traction motor (M_{E}) 24, thus causing machine rotation. Output torque (arrow T_{O}) from the electric traction motor 24 may be delivered to one or more road wheels 15 of the donor 12D when the illustrated charging process is not being performed.

The recipient 12R shown in FIG. 1 may be similarly or identically configured to include a corresponding charge port 116, traction battery pack 118, DCFC contactors 120, PIM 122, and electric traction motor 124. Thus, in addition to being equipped to perform the V2V charging process 10 shown in FIG. 1, the respective electric powertrain systems 50D and 50R are also configured, during separately conducted discharging modes of the battery packs 18 and 118, to electrically propel the corresponding donor 12D and recipient 12R. In other words, the donor 12D and recipient 12R in the illustrated embodiment of FIG. 1 are both mobile systems capable of performing propulsion functions apart from the described V2V charging process 10 described herein.

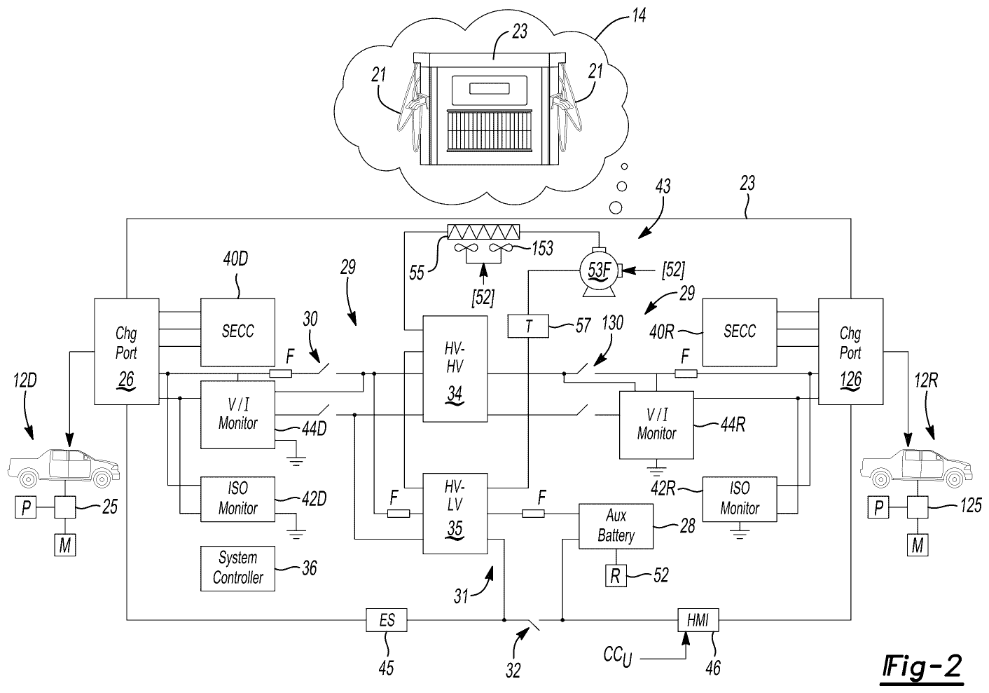

Referring to FIG. 2, which illustrates a representative construction of the V2V charging unit 14, the traction battery pack 118 (FIG. 1) of the recipient 12R may become sufficiently charge-depleted during operation of the recipient 12R that the owner/operator of the recipient 12R requires charging. When this situation occurs, the recipient 12R may not be in proximity to an available EVSE charging station or a home/office charging station. In such a scenario, the owner/operator in accordance with the present teachings could request performance of the V2V charging process 10 as a mobile DCFC charging session. During this event, the portable V2V charging unit 14 is transportable to the site of the recipient 12R, for instance by the donor 12D, the recipient 12R, or another vehicle such as a third-party roadside service provider. The aforementioned charging ports 16, 116 are able to receive SAE J1772, national charging standard (NACS), combined charging system (CCS), CHAdeMO, or other suitable charge connectors connected to or integrated with the charging cables. An electric power take-off (cPTO) port on the donor 12D/recipient 12R commonly used for mobile machinery may be used in one or more embodiments enabling the DC power discharge contemplated herein.

The donor 12D and the recipient 12R are respectively equipped with an onboard electric vehicle (EV) controller 25, 125 having one or more processors (P) and a non-transitory computer-readable storage medium (memory) (M). Through cooperation with circuitry of the intervening V2V charging unit 14, the donor 12D and the recipient 12R are equipped to communicate via the exchange of data during the V2V charging process 10, manage and coordinate powerflow, monitor for proper connection of the charging cables/connectors and other conditions/error states, regulate temperature of the V2V charging unit 14, and perform other relevant functions as described below.

V2V CHARGING UNIT (14): The V2V charging unit 14, being a sufficiently rugged and optionally portable device, includes a housing 23 having a donor charging port 26 and a recipient charging port 126. The housing 23 may be constructed of a lightweight, weatherproof material such as aluminum or rugged plastic. In some implementations, charging cables and connectors 21 may be connected to the donor and recipient charging ports 26 and 126 as part of the V2V charging unit 14, or the charging cables and connectors 21 may be provided by the owners/operators of the respective donor 12D and recipient 12R. The donor and recipient charging ports 26 and 126 are thus selectively connectable to the donor 12D and the recipient 12R, respectively, via the corresponding charging cables and connectors 21.

In the illustrated construction of FIG. 2, an auxiliary battery 28, e.g., a 12V lead acid or lithium ion battery, is connected to the housing 23. The auxiliary battery 28 may be part of the V2V charging unit 14 as shown or connected externally, e.g., via a corresponding auxiliary port (not shown) on the housing 23. A variety of electrical components are packaged within a volume of the housing 23. These include a high-voltage (HV) bus 29 having donor and recipient HV disconnect devices 30, 130, for instance high-voltage electrical contactors, single-pull/single-throw (SPST) switches, or solid-state relays (SSRs) as appreciated in the art, with possible ratings of at least 1000V and 300 A to cover the current gamut of EV charging voltages and expected currents. The HV bus 29 is connectable to the donor 12D and recipient 12R via the respective donor and recipient HV disconnect devices 30 and 130, respectively.

Also packaged within the housing 23 is a low-voltage (LV) bus 31 having an auxiliary switch 32 embodied as, e.g., a manually-actuated push button device, a manually-actuated push button device, a smart switch, or a switching device activated via a control signal from an HMI or another external device, or a command from a mobile app. A bi-directional, buck-boost HV-to-HV converter 34 is connected to the HV bus 29 between the donor and recipient HV disconnect devices 30, 130, and a bi-directional, buck-boost HV-to-LV converter 35 connected to the HV bus 29 and the LV bus 31. The converter 34 in one or more non-limiting embodiments may be isolated or non-isolated, single-phase or multi-phase, and rated for at least 50 kilowatts (kW), with “high-voltage” being voltage levels of, e.g., 150V to 1000V or more. In other embodiments, the converter 34 may be constructed from multiple connected converters 34 each having a power rating of, e.g., 25 kW, 50 KW, 75 KW, 100 KW, or another higher or lower rating depending on the embodiment.

Still referring to FIG. 2, the V2V charging unit 14 also includes a system controller 36 that is connectable to the LV bus 31 via the auxiliary switch 32. For instance, the system controller 36 may remain unenergized until owners/operators of the donor 12D and recipient 12R decide to initiate the V2V charging process 10 of FIG. 1. In that case, the auxiliary switch 32 may be closed to connect the system controller 36 to the LV bus 31 to initiate the V2V charging process 10. In a “smart” system, initiation may be performed using a mobile app to enable the auxiliary battery 28 to provide the necessary battery current for turning on the system controller 36 or other loads. The system controller 36 is configured to communicate internally and with other components of the donor 12D and recipient 12R using, e.g., controller area network (CAN) signals, analog/discrete signals, ISO/SPI, etc.

Also packaged within the housing 23 of FIG. 2 is a supply equipment communication controller (SECC) 40D and 40R for the respective donor 12D and recipient 12R. As contemplated herein, the SECC 40D, 40R are configured to detect charge port control signals via the donor charging port 26 and the recipient charging port 126, and to establish communications between the SECCs 40D, 40R and the system controller 36 when performing the V2V charging process 10. Thus, the SECCs 40D, 40R (separate components as shown or one component) performs the requisite “handshaking” with the EV controllers 25, 125 of the respective donor 12D and recipient 12R.

Additionally, separate donor and recipient isolation monitoring circuits 42D, 42R are configured to determine an isolation state of the HV bus 29 and an OPEN/CLOSED state of the donor and recipient HV disconnect devices 30, 130. Similarly, separate donor and recipient voltage/current monitoring circuits 44D, 44R are configured as respective first and second electrical sensors or sensor suites which measure and monitor corresponding voltage and current levels on the HV bus 29, and which ensure proper fault-free operation of the V2V charging unit 14. Fuses (F) are also included on the HV bus 29 and LV bus 31 for overcurrent protection, with the fuses (F) variously configured as, e.g., thermal fuses, e-fuses, or pyrotechnic fuses in different implementations.

The system controller 36 illustrated in FIG. 2 is connectable to the auxiliary battery 28 and is in communication with the HV-to-HV converter 34, the HV-to-LV converter 35, the donor and recipient HV disconnect devices 30 and 130, and the SECCs 40D and 40R. During the V2V charging process 10 of FIG. 1, the system controller 36 selectively commands an offloading of a DC charging current from the battery pack 18 (FIG. 1) of the donor 12D, through the HV-to-HV converter 34, and to the battery pack 180 of the recipient 12R shown in FIG. 1.

The V2V charging unit 14 of FIG. 2 in one or more embodiments includes a thermal management system (TMS) 43. Portions of the V2V charging unit 14 may be placed inside of the donor and/or recipient 12D and/or 12R depending on component size, or integrated therewith. This would enable the V2V charging unit 14 to share some of its components with parts of the donor 12D/recipient 12R, such as the TMS 43, e.g., a custom cooling line or port connection, 12V/24V/48V auxiliary power via an auxiliary power outlet, etc. The TMS 43 and other components of the V2V charging unit 14 are therefore shown in FIG. 2 in a possible self-contained portable construction without limiting the present teachings to such an embodiment.

The TMS 43 may be connected to the HV-to-LV converter 35, the HV-to-HV converter 34 in the illustrated configuration in which the TMS 43 includes a motorized fan and/or pump 53F configured to circulate air or coolant (e.g., from a tank 57) to the HV-to-HV converter 34 and the HV-to-LV converter 35. A heat exchanger or evaporator 55 may be used as part of this process to facilitate extraction of heat from the converters 34 and 35. In such an embodiment, a relay 52 (connections omitted for illustrative clarity) may selectively disconnect the TMS 43 from the auxiliary battery 28 in response to relay control signals from a relay 52 via the system controller 36. That is, the TMS 43 is used for heat management of the converters 34 and 35, with auxiliary power from the auxiliary battery 28 used to turn on the fan/pump 53F and keep it/them running for as long as is needed. Similarly, the V2V charging unit 14 may include an emergency stop (ES) button 45 located in or in proximity to the housing 23, with depression of the emergency stop button 45 serving to initiate immediate termination of the V2V charging process 10.

Additional components of the V2V charging unit 14 of FIG. 2 may include a human-machine interface (HMI) 46, e.g., a touch screen display, that is connected to the portable housing 23. The HMI 46 may be configured to receive user inputs (CCt) to the system controller 36 during the V2V charging process 10 and display information pertaining thereto. For instance, in one or more implementations the system controller 36 may be configured to quantify the V2V charging process 10 upon its completion, generate a summary of charges for the V2V charging process 10, and communicate the summary of charges to an owner/operator or other user of the recipient 12R, e.g., wirelessly. The system controller 36 may also be configured to perform an adaptive self-learning algorithm to analyze charging behavior of a group of recipients 12R from prior V2V charging processes 10, and to adjust performance of the V2V charging unit 14 over time based on such past charging behavior.

The V2V charging unit 14 may be optionally equipped with a unique identifier (ID) code, for instance a unique string of numbers and/or letters uniquely identifying the V2V charging unit 14 from among a larger population of similarly equipped V2V charging units 14. Such an ID code would facilitate such process quantification as well as security/validation. To that end, a wireless interface may be configured to remotely enable pairing of the donor 12D and the recipient 12R in response to the unique ID code matching a corresponding ID code stored in respective memory (M) of the donor 12D and the recipient 12R.

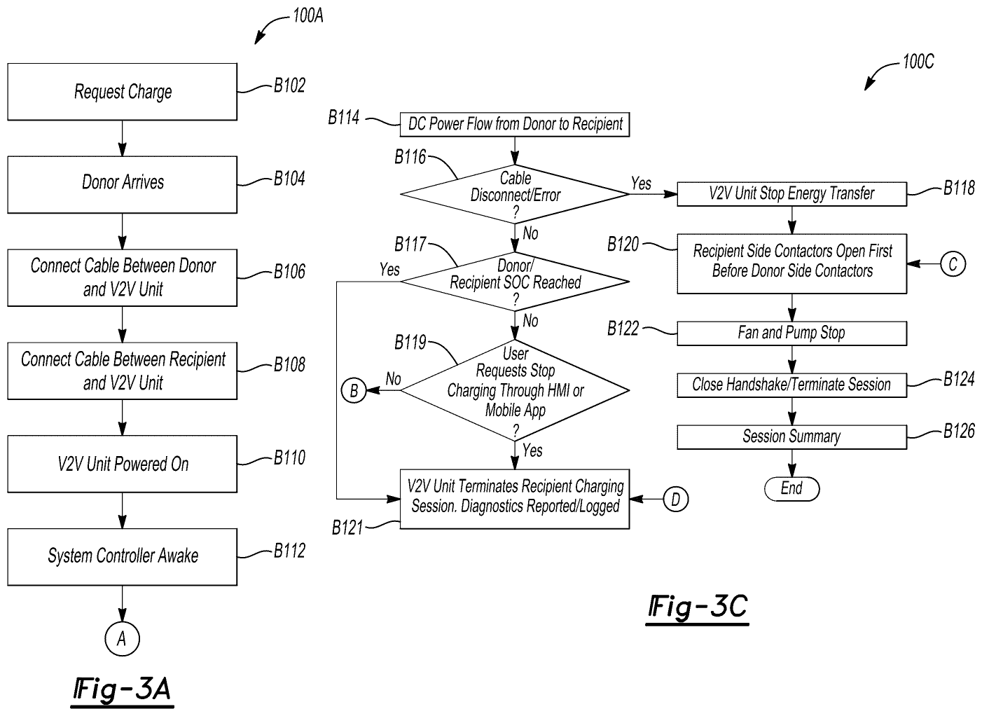

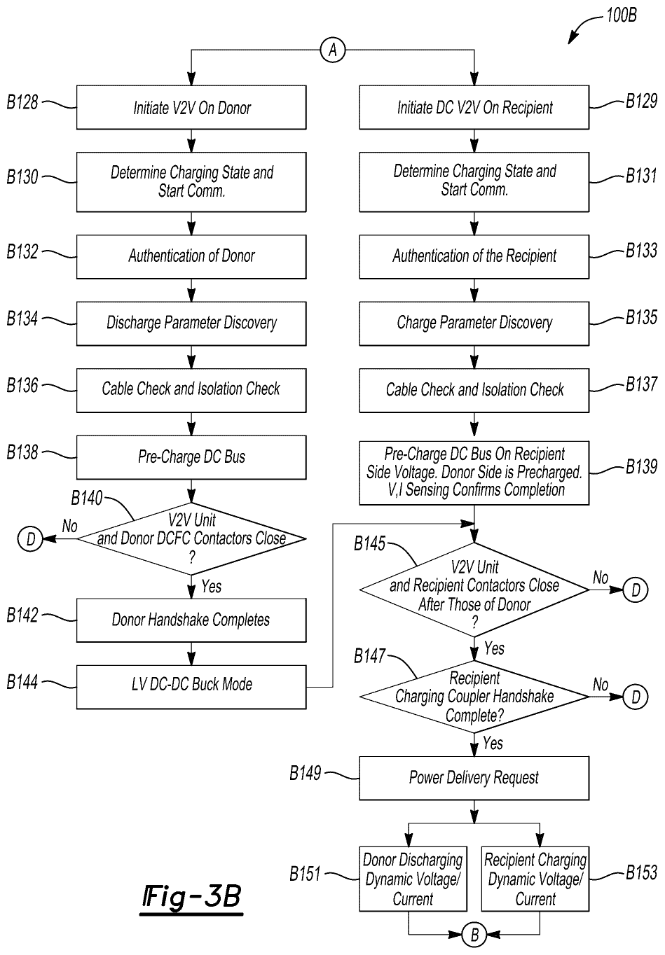

SYSTEM CONTROLLER (36): The system controller 36, which lies at the heart of the V2V charging process 10 of FIG. 1, is configured to supervise, monitor, and control the various functions needed for performing the process 10. The system controller 36 works in concert with the SECCs 40D and 40R throughout the process 10. The functions of the V2V charging unit 14 of FIG. 2 are described in an exemplary implementation via flowcharts in FIGS. 3A, 3B, and 3C, respectively, with the flowcharts collectively describing a process for performing the V2V charging process 10 of FIG. 1 via corresponding processes 100A, 100B, and 100C. That is, the V2V charging process 10 is broken up for illustrative clarity into the V2V charging processes 100A, 100B, and 100C, which together form the charging process 10 as described herein.

With respect to the system controller 36 of FIG. 2, this component control unit may be equipped with electrical connectors and/or wireless connections to communicate with the various other control or sensor devices described above. Although omitted for clarity and simplicity, functions of the system controller 36 and other control devices occurs by executing computer-readable instructions from a tangible, non-transitory computer-readable storage medium analogous to the memory (M) of the EV controllers 25 and 125. Such memory may include magnetic or optical media, CD-ROM, and/or solid-state/semiconductor memory (e.g., various types of RAM or ROM).

Although shown schematically in FIG. 2 for simplicity, the system controller 36 and other depicted control devices may be embodied as a control module, control unit, processor, and similar terms may refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). Non-transitory components of the memory used herein are capable of storing machine-readable instructions in the form of one or more software or firmware programs or routines, combinational logic circuit(s), input/output circuit(s) and devices, signal conditioning and buffer circuitry and other components.

Mobile plug-in functions as contemplated herein involve the coordinated two-way communication of data between the donor 12D and the recipient 12R. Data exchange regulated by the SECCs 40D, 40R entails a transmission of a low-voltage control pilot or communications (Comms) signal, typically in the range of 0-12V, and a proximity voltage signal of 0-5V. An electrical ground is also provided. An established J1772 connection, for instance, allows respective processors of the donor 12D and the recipient 12R to communicate with each other using Power Line Communication (PLC) for the comms signal, which in turn progresses in accordance with an established communications protocol via a coordinated exchange of data messages. The comms signal is ordinarily used to verify a connection between an offboard EVSE charging station and a charging EV, whose respective places are taken herein by the donor 12D and the V2V charging unit 14 (together acting as such an EVSE charging station) and the recipient 12R, to communicate charging states. This may occur, e.g., using a fixed duty cycle during the contemplated DC charging. The same signal may be used to adjust the charging rate as needed. Other standards such as the above-noted NACS, CCS, CHAdeMO, etc., may be used in a similar vein, and therefore the particular charging standard may vary with the desired end use.

The V2V charging process 10 of FIG. 1 is coordinated via an exchange of data/messages between the EV controller 25 of the donor 12D, the system controller 36 and SECCs 40D, 40R of the V2V charging unit 14, and the corresponding EV controller 125 of the recipient 12R, e.g., a Battery Management System or another battery controller. The above-noted comms and proximity signals are exchanged per a predetermined protocol, with the general process of DC charging under DIN 70121 or other relevant protocols being well understood in the art, such as international protocols/standards like ISO 15118-20, ISO 15118-2, etc. Such protocols proceed in accordance with a defined multi-step electronic “handshaking” process before permitting transfer of energy, with this process also noted below in the description of the charging process 10. Wireless communication may be facilitated via one or more communication modules connected to/usable with, e.g., BLE/WiFi/LTE.

FIGS. 3A, 3B, and 3C collectively represent an embodiment of the charging process 10 using discrete process steps, segments, or logic blocks for clarity. Each constituent block of the charging process 10 may be implemented in the sequence set forth herein to conduct the V2V charging process 10 of FIG. 1 using the representative hardware of FIG. 2.

Referring first to FIG. 3A, the charging process 100A commences with block B102 with a request for an emergency charge of the recipient 12R of FIGS. 1 and 2. For example, an owner/operator of the recipient 12R could transmit a request to an owner/operator of the donor 12D, request the V2V charging process 10 via an SMS text message or a phone call, using OnStar®, or otherwise signal a need or desire for the V2V charging process 10. The charging process 100A then proceeds to block B104.

At block B104, the donor 12D arrives on site and is parked in proximity to the recipient 12R. The donor 12D in this instance could pull up in front of or next to the recipient 12R such that the charging ports 16 and 116 are readily accessible to one other. The charging process 100A thereafter proceeds to block B106.

Block B106 of FIG. 3A includes connecting the charging cable 23 to the donor 12D and the V2V charging unit 14 of FIGS. 1 and 2. For example, the charging cable 23 may be a CCS/NACS charging cable as noted above, in which case one end of the cable 23 could be plugged into the charging port 16 on the donor 12D. The charging process 100A proceeds from block B106 to block B108 once the charging cable 23 has been securely connected to the donor 12D.

At block B108, which is analogous to block B106, another charging cable 23 is connected between the charging port 116 of the V2V charging unit 14 and the charging port 116 of the recipient 12R. Upon completion of block B108, the donor 12D is electrically connected to the recipient 12R via the intervening V2V charging unit 14. The charging process 100A thereafter proceeds to block B110.

Block B110 of FIG. 3A includes powering on the V2V charging unit 14. This includes energizing the system controller 36 of the V2V charging unit 14 via low voltage power from the LV bus 31. For instance, the auxiliary switch 32 of FIG. 2 may be manually-activated or manually-actuated to connect the LV bus 31 to the system controller 36. The charging process 100A thereafter continues to block B112.

At block B112, the system controller 36 is energized and awake. As the LV bus 31 is energized, one or more 12V loads may likewise be energized and awake at this stage of the charging process 100A. The energized/awake state of the system controller 36 corresponds to point A in the illustrated process flow of FIG. 3A.

Referring now to the charging process 100B of FIG. 3B, and commencing at point A of FIG. 3A, the charging process 100B proceeds to blocks B128 and B129 to commence functions of the donor 12D, and to block B129 to commence functions of the recipient 12R. Using the HMI 46 of FIG. 2, for instance, a user may request charging via the donor 12D, which would then initiate the remaining charging sequence. The charging process 100B proceeds to blocks B130 and B131 upon completion of blocks B128 and B129, respectively.

As illustrated in FIG. 3B, block B128 is analogous to block B129, block B130 is analogous to block B132, block B132 is analogous to block B133, and so forth. Block B139 described below pertains to precharging of the recipient 12R, which occurs once precharging of the donor 12D is complete and contactors of the donor 12D close, i.e., after blocks B138 and 140 are completed.

Blocks B130 and B131 entail detecting charge port control signals via the SECCs 40D, 40R. The charge port signals are indicative of an electrical connection of the donor 12D and recipient 12R. As appreciated in the art, this may entail checking CP voltage, duty cycle, and resistance via the SECC 40D, 40R of the respective donor 12D and recipient 12R and initiating two-way communications between the EV controllers 25 and 125.

Blocks B132 and B133 may include authenticating the donor 12D and recipient 12R, e.g., by determining whether an electronic handshake signal such as Transport Layer Security (TLS) handshake has been received from the recipient 12R by the donor 12D (block B132) and vice versa (block B133).

Establishing handshaking/communications between the SECCs 40D, 40R and the system controller 36 in response to the charge port control signals is therefore used to initiate the V2V charging process 10. As appreciated in the art, such a handshake signal is often used to establish an encrypted two-way communication session between a charge provider and a charge recipient during EV charging. This is extended to the present V2V charging process 10. The charging process 100B proceeds to blocks B134 and B135 after authentication is completed.

At blocks B134 and B135 of FIG. 3B, the donor 12D and recipient 12R communicate their respective voltage, current, power, and state of charge (SOC) limits to the V2V charging unit 14 over the established connection through the intervening charging cables 23. Through the intervening V2V charging unit 14 and its resident system controller 36 and SECCs 40D, 40R, the EV controllers 25 and 125 of the respective donor 12D and recipient 12R are each made aware of the capabilities of the other. The V2V charging unit 14 responds to the successful handshake by pre-charging the DC bus 56 of FIG. 3. The charging process 100B thereafter proceeds to blocks B136 and B137.

Blocks B136 and B137 entail performing a check of the cables 23 and isolation, the latter using the above-noted isolation monitors 42D and 42R of FIG. 2. The charging process 100B thereafter proceeds to blocks B138 and B139.

Continuing the discussion of the charging process 100B, blocks B138 and B139 include pre-charging the HV bus 29 on the side of the donor 12D (block B138) and thereafter pre-charging the HV bus 29 on the side of the recipient 12R (block B139). To that end, the HV-to-LV converter 38 of FIG. 2 may be operated in boost mode such that internal switching and power transforming operations of the HV-to-LV converter 35 are used to increase the voltage level of the LV energy storage device 28 to match the higher-voltage level of the donor 12D. The charging process 100B thereafter proceeds to blocks B140 and B145.

Part of the V2V charging process 10 includes commanding donor and recipient HV disconnect devices 30, 130 on the HV bus 29 to close, via the system controller 36, thereby connecting the HV-to-HV converter 34 to the HV bus 29, recharging the LV bus 31 via the HV-to-LV converter 45, and using the separate donor and recipient monitoring circuits 44D, 44R of FIG. 2 to determine an isolation state of the HV bus 29 and an OPEN/CLOSED state of the donor and recipient HV disconnect devices 30, 130. This occurs before selectively commanding offloading a DC charging current from the traction battery pack 18 of the donor 18D through the HV-to-HV converter 45 to the traction battery pack 118 of the recipient 12R.

To that end, block B140 of FIG. 3B includes determining, via the system controller 36 of the V2V charging unit 14, whether the DCFC contactors 20 (FIG. 2) located aboard the donor 12D are closed, and also whether the first set of disconnect devices 30 of the V2V charging unit 14 of FIG. 2 are likewise closed. The charging process 100B proceeds to block B142 of FIG. 3B once the DCFC contactors 20 and the first set of disconnect devices 30 of the V2V charging unit 14 are closed, and returns to block B121 of FIG. 3C in the alternative when the DCFC contactors 20 or the disconnect devices 30 are in an open state.

Block B142 includes completing the handshake of the donor 12D with the recipient 12R and registering a bit flag or suitable code in memory of the system controller 36 indicative of the same. The charging process 100B thereafter proceeds to block B144.

At block B144, the system controller 36 transitions the HV-to-LV converter 35 into a voltage-reducing “buck” mode to maintain the auxiliary battery 28 or other low-voltage energy storage system at a calibrated low voltage level, nominally about 12-15V. The charging process 100B proceeds to block B145 once the buck mode has been enacted.

At block B145 of FIG. 3B, which is analogous to block B140, the system controller 36 next verifies that the HV disconnect devices 130 of the V2V charging unit 14 and the DCFC contactors 120 of the recipient 12R closed. When closed, the charging process 100B proceeds to block B147. The charging process 100B proceeds in the alternative to block B121 of FIG. 3C (point D).

Block B147 includes determining completion of the handshake with the donor 12D and registering a bit flag or suitable code in memory of the system controller 36 indicative of the same. The charging process 100B thereafter proceeds to block B149, or to block B121 (point D) when the system controller 36 is unable to determine that the handshake has completed.

Block B149 includes requesting delivery of charging power from the donor 12D. Block B149 may entail communication of such a request by the SECC 40R to the system controller 36, with the system controller 36 thereafter communicating via the SECC 40D with the EV controller 25 aboard the donor 12D. The charging process 100B then proceeds to blocks B151 and B153.

At blocks B151 and B153, the donor 12D and recipient 12R respectively discharge and receive a suitable charging current/voltage. The magnitude of either may be dynamically varied by the system controller 36, e.g., via commands to the various control nodes of the V2V charging unit 14, to charge the battery pack 118 aboard the recipient 12R. The charging process 100B is thus completed at point B of FIG. 3, which proceeds to block B114 of FIG. 3C.

Referring now to FIG. 3C, and beginning at block B114, the charging process 100C proceeds by controlling operation of the V2V charging unit 14 to control power flow from the donor 12D to the recipient 12R. The charging process 100C continues to block B116 as this continues.

Block B116 includes scanning for a cable/disconnect error. Such an error could arise if either of the charging cables 23 of FIG. 2 should become loose or disconnected. The charging process 100C proceeds to block B118 in the event such an error is detected. The charging process 100C proceeds in the alternative to block B117 in the absence of such an error.

At block B117, the system controller 36 of FIG. 2 verifies whether a respective state of charge (SOC) of the donor 12D and recipient 12R have reached a predetermined SOC limit. If so, the charging process 100C proceeds to block B121, with the charging process 100C otherwise continuing to block B119.

Block B118 includes discontinuing energy transfer through the V2V charging unit 14. Block B118 may entail setting a bit code to register this change in state, with the setting of the bit code triggering subsequent blocks B120, B122, B124, and B126.

At block B119, the system controller 36 next determines whether a user has requested termination of the V2V charging process 10. For example, the owner/operator of the donor 12D or recipient 12R may communicate a desire to stop the V2V charging process 10 via wireless or HMI-based communication with the system controller 36, e.g., via the HMI 46 of FIG. 2 and/or via an app of a cell phone or tablet computer. The charging process 100C proceeds to block B121 when the user requests that the V2V charging process 10 should cease.

At block B120, the DCFC contactors 120 of the recipient 12R may be commanded open, which occurs prior to commanding open the DCFC contactors 20 of the donor 12D. The charging process 100C then proceeds to block B122.

Block B121 includes terminating the V2V charging process 10. This could entail transmitting requisite signals from the EV controller 125 of the recipient 12R to the system controller 36 of the V2V charging unit 14 indicating the recipient 12R no longer requires charging. As part of block B121, the system controller 36 may command the disconnect device 130 to open, thus breaking the high-voltage connection between the V2V charging unit 14 and the recipient 12R. Aboard the recipient 12R, the DCFC contactors 120 of FIG. 1 are likewise commanded to open. The charging process 100C then proceeds to block B120.

At block B122, the system controller 36 may command the TMS 43 to cease functioning. This may include commanding the fan and pump 53F of FIG. 2 to stop. The charging process 100C then proceeds to block B124.

Block B124 entails terminating the V2V charging process 10 before proceeding to block B126.

At block B126 of FIG. 3C, the system controller 26 may optionally generate a summary of the charging time, kilowatt hours (kWhr), and possibly an associated financial charge for the V2V charging process 10. This allows the system controller 26 to quantify the DCFC charging process upon completion thereof, generate a summary of charges for the DCFC charging process, and communicate the summary of charges to a user of the recipient, e.g., via a smart phone, email, electronic funds transfer, etc. The charging process 100C is complete once block B126 has been performed.

The mobile DCFC-related hardware and software solutions described above thus provide an electrical architecture that enables energy transfer to occur between two EVs or other battery electric systems equipped having a high-voltage rechargeable energy storage system, exemplified herein as the traction battery packs 18 and 118 of FIG. 1. The portability of the V2V charging unit 14 and its configured capabilities together enable faster, more flexible, and user-convenient mobile charging in a V2V context relative to such alternative approaches. These and other attendant benefits will be readily understood by those skilled in the art in view of the foregoing disclosure.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A charging unit for performing a charging process between a charge-providing system (“donor”) and a charge-receiving system (“recipient”), comprising:
a housing having a donor charging port and a recipient charging port that are selectively connectable to the donor and the recipient, respectively, via corresponding charging cables and connectors;
an auxiliary battery connected to the housing; and
packaged within the housing:
a high-voltage (HV) bus having donor HV disconnect devices and recipient HV disconnect devices, wherein the HV bus is connectable to the donor and the recipient via the donor HV disconnect devices and the recipient HV disconnect devices, respectively;
a low-voltage (LV) bus having an auxiliary switch;
a bi-directional, buck-boost HV-to-HV converter connected to the HV bus between the donor HV disconnect devices and the recipient HV disconnect devices;
a bi-directional, buck-boost HV-to-LV converter connected to the HV bus and the LV bus;
a system controller connectable to the LV bus via the auxiliary switch;
a supply equipment communication controller (SECC) configured to detect charge port control signals via the donor charging port and the recipient charging port, and to establish communications between the SECC and the system controller in response to the charge port signals;
respective donor and recipient isolation monitoring circuits configured to determine an isolation state of the HV bus and an OPEN/CLOSED state of the donor and recipient contactors; and
a system controller connectable to the auxiliary battery and in communication with the HV-to-HV converter, the HV-to-LV converter, the donor and recipient HV disconnect devices, and the SECC, the system controller being configured to selectively command an offloading of a DC charging current from a battery pack of the donor, through the HV buck-boost converter, and to a battery pack of the recipient.

2. The charging unit of claim 1, wherein the donor and recipient monitoring circuits respectively include a first electrical sensor and a second electrical sensor each configured to measure a corresponding voltage and current on the HV bus.

3. The charging unit of claim 1, wherein the auxiliary switch is a manually-actuated push button device.

4. The charging unit of claim 1, further comprising:
a thermal management system (TMS) connected to the auxiliary battery, the HV-to-HV converter, and the HV-to-LV converter; and
a relay that selectively disconnects a fan or pump of the TMS from the auxiliary battery to energize the fan or pump in response to a relay control signal from the system controller.

5. The charging unit of claim 4, wherein the TMS includes a motorized fan or pump configured to circulate air or coolant to the HV-to-HV converter and the HV-to-LV converter.

6. The charging unit of claim 1, further comprising:
a human-machine interface (HMI) connected to the housing, wherein the HMI is configured to receive user inputs to the system controller and to display information pertaining to the charging process.

7. The charging unit of claim 1, wherein the system controller is configured to quantify the charging process upon completion thereof, generate a summary of charges for the charging process, and communicate the summary of charges to a user of the recipient.

8. The charging unit of claim 1, wherein the system controller is configured to perform an adaptive self-learning algorithm to analyze charging behavior of a group of recipients from prior charging processes, and to adjust performance of the charging unit over time based on the charging behavior.

9. The charging unit of claim 1, wherein the recipient and the donor are configured as electric vehicles, and wherein the charging process is a vehicle-to-vehicle charging process.

10. The charging unit of claim 1, further comprising: the charging cables and connectors.

11. The charging unit of claim 1, wherein the auxiliary battery is located within the housing.

12. The charging unit of claim 1, wherein the donor HV disconnect devices and the recipient HV disconnect devices include contactors, single-pull single-throw switches, or solid-state relays.

13. The charging unit of claim 1, wherein the HV-to-HV converter is rated for at least about 50 kW and about 150V to about 1000V.

14. The charging unit of claim 1, wherein the charging unit has a unique identifier (ID) code, wherein the charging unit is configured to remotely enable pairing of the donor and the in response to the unique ID code matching a corresponding ID code stored in respective memory of the donor and the recipient.

15. A vehicle-to-vehicle (V2V) charging process, comprising:
energizing a system controller of a V2V charging unit via a low-voltage (LV) bus in response to actuation of an auxiliary switch;
detecting charge port control signals via a supply equipment communication controller (SECC) of a V2V charging unit, the charge port signals being indicative of an electrical connection of a charge-providing vehicle (“donor”) and a charge-receiving vehicle (“recipient”);
establishing handshaking/communications between the SECC and a system controller of the V2V unit in response to the charge port control signals to thereby initiate a V2V charging process; and
during the V2V charging process:
commanding separate donor and recipient HV disconnect devices on an HV bus of the V2V charging unit to close, via the system controller, thereby connecting a bi-directional, buck-boost HV-to-HV converter to the HV bus;
recharging the LV bus via a bi-directional, buck-boost HV-to-LV converter;
monitoring separate donor and recipient monitoring circuits of the V2V charging unit to determine an isolation state of the HV bus and an OPEN/CLOSED state of the donor and recipient HV disconnect devices; and
selectively commanding an offloading of a DC charging current from a battery pack of the donor, through the HV-to-HV converter, and to a battery pack of the recipient.

16. The V2V charging process of claim 15, wherein the V2V charging unit includes a thermal management system (TMS), further comprising:
regulating a respective temperature of the HV-to-HV converter and the HV-to-LV converter via the TMS during the V2V charging process.

17. The V2V charging process of claim 15, further comprising:
generating a summary of charges for the V2V charging process via the system controller; and
communicating the summary of charges to the recipient via a wireless communications link.

18. A vehicle system, comprising:
a charge-providing (“donor”) electric vehicle (EV) having a first traction battery pack;
a charge-receiving (“recipient”) EV having a second traction battery pack; and
a vehicle-to-vehicle (V2V) charging unit configured to perform a V2V charging process of the recipient EV by the donor EV, the V2V charging unit including:
a housing having a donor charging port and a recipient charging port that are selectively connectable to the donor and the recipient, respectively, via corresponding charging cables and connectors;
an auxiliary battery connected to the housing; and
packaged within the housing:
a high-voltage (HV) bus having donor and recipient HV disconnect devices, wherein the HV bus is connectable to the donor and recipient via the donor and recipient HV disconnect devices, respectively;
a low-voltage (LV) bus having an auxiliary switch;
a bi-directional, buck-boost HV-to-HV buck-boost converter connected to the HV bus between the donor and recipient HV disconnect devices;
a bi-directional, buck-boost HV-to-LV buck-boost converter connected to the HV bus and the LV bus;
a system controller that is connectable to the LV bus via the auxiliary switch;
a supply equipment communication controller (SECC) configured to detect charge port control signals via the donor charging port and the recipient charging port, and to establish communications between the SECC and the system controller;
donor and recipient monitoring circuits configured to determine an isolation state of the HV bus and an OPEN/CLOSED state of the donor and recipient HV disconnect devices; and
a system controller connectable to the auxiliary battery and in communication with the HV-to-HV converter, the HV-to-LV converter, the donor and recipient HV disconnect devices, and the SECC, and configured during the V2V charging process to selectively command an offloading of a DC charging current from a battery pack of the donor, through the HV converter, and to a battery pack of the recipient.

19. The vehicle system of claim 18, wherein the V2V charging unit includes:
a thermal management system (TMS) connected to the auxiliary battery, the HV-to-HV converter, and the HV-to-LV converter; and
a relay that selectively disconnects a fan or pump of the TMS from the auxiliary battery to energize the fan or pump in response to a relay control signal from the system controller.

20. The vehicle system of claim 18, wherein the system controller is configured to perform an adaptive self-learning algorithm to analyze charging behavior of a group of recipients from prior charging processes, and to adjust performance of the V2V charging unit over time based on the charging behavior.
